(19) United States
(12) Patent Application Publication
(10) Pub. No.: US 2014/0280960 A1
(43) Pub. Date: Sep. 18, 2014

(54) METHODS AND APPARATUS FOR DYNAMICALLY ALLOCATING DEVICES BETWEEN MULTIPLE CONTROLLERS

(71) Applicant: Apple, Inc., Cupertino, CA (US)

(72) Inventors: Arulchandran Paramasivam, Cupertino, CA (US); Barry Twycross, Cupertino, CA (US); Edward H. Frank, Cupertino, CA (US); Eric W. Anderson, Cupertino, CA (US); Fernando A. Urbina, Cupertino, CA (US); Steven J. Sfarzo, Cupertino, CA (US); William O. Ferry, Cupertino, CA (US)

(21) Appl. No.: 13/842,147

(22) Filed: Mar. 15, 2013

(51) Int. Cl. H04L 12/911

(52) U.S. Cl. CPC H04L 47/70
USPC 709/226

(57) ABSTRACT

Methods and apparatus for dynamically allocating resources to a plurality of controllers are disclosed. In one embodiment, the controllers comprise multiple types of Universal Serial Bus compliant controllers. When a USB-compliant device is detected, one or more determinations are made regarding the detected device such as the supported data transfer speed capabilities. Based on the one or more determinations, the device is directed to an appropriate controller.

### RELATED APPLICATIONS

This application is related to co-owned and co-pending U.S. patent application Ser. No. 13/658,686 filed Oct. 23, 2012 and entitled “SHARING A GRAPHICS-PROCESSING-UNIT DISPLAY PORT”, the foregoing being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technical Field

The present disclosure relates generally to the field of computerized devices, data networks and buses. More particularly, in one exemplary aspect, the present disclosure is directed to dynamically allocating resources to resource controllers.

2. Description of Related Technology

In a typical computer system, the computer system has various interfaces or connections that are managed by internal controllers. However, the internal controllers are typically fixed to particular interface connections, offering devices connected via those interface connections only the functionality as those supported by the associated controller. In the exemplary context of serialized bus protocols such as e.g., the Universal Serial Bus (USB) protocol standard(s), USB 3.0 controllers are compliant with both USB 3.0 speeds, in addition to supporting USB 2.0 speeds. In order to offer such support, the USB 3.0 controller has port connections for both USB 2.0-compliant bus lines in addition to USB 3.0 “SuperSpeed” compliant bus lines.

Both USB 3.0 and 2.0 devices use a connector form factor of similar physical configuration, but with different electrical connections. This permits a user to connect a USB 3.0 device into a USB socket connector managed only by a USB 2.0 compliant controller. Thus, the USB 3.0 device will not be able to connect at SuperSpeed as the USB 2.0 controller lacks the requisite support. Accordingly, a user may not be aware that they connected the device to a port that does not fully support the device, as the user was successfully able to physically insert the connector of the device. Prior art solutions attempted to solve the problem of such “incorrect” USB port use by color-coding the USB ports and connectors of USB devices compliant with USB 3.0. However, this approach is of somewhat questionable utility, as it, inter alia, requires the user to be cognizant of the meaning of the colors, and take appropriate action (or not take action) based thereon, thereby reducing ease of use and user experience.

In addition, as certain USB ports may have separate and distinct USB controllers, and USB devices requiring varying amount of resources, a particular USB controller with one or more connected devices may have high resource usages, such as endpoint resources, while a separate USB controller may have low resource utilization.

Accordingly, there exists a need to improve upon the deficiencies associated with these prior art approaches. Specifically, methods and apparatus for dynamically allocating connections for devices to a suitable available controller are needed. At the same time, such methods and apparatus ideally would be able to intelligently allocate the devices to resources in order to, e.g., balance the operational load between the suitable controllers.

### SUMMARY

The present disclosure satisfies the foregoing needs by providing, inter alia, methods and apparatus for efficiently servicing devices of a data network. In one aspect, a method for dynamically allocating resources to a plurality of resource controllers is disclosed. In one embodiment, the method includes: detecting one or more parameters associated with a resource; selecting at least one resource controller of the plurality of resource controllers for the resource based at least in part on the detected one or more parameters; and routing a connection to the selected at least one resource controller.

In another aspect, a host device configured to dynamically allocate device resources among a plurality of resource controllers is disclosed. In one embodiment, the host device includes: at least one interface; a plurality of resource controllers; and computerized logic in data communication with the at least one interface and the plurality of resource controllers. In one variant, the computerized logic is configured to cause the host device to: identify at least one device attempting to establish a new connection with the host device via the at least one interface; determine one or more characteristics of the at least one device; and based at least in part on the one or more characteristics, select at least one resource controller of the plurality of resource controllers to associate with the at least one device.

In another aspect, a non-transitory computer readable apparatus is disclosed. In one embodiment, the apparatus includes a storage medium with at least one computer program disposed thereon, the at least one program comprising a plurality of instructions for dynamically allocating resources between a plurality of managing entities stored thereon. In one variant, the plurality of instructions are configured to, when executed by a processor, cause a host apparatus to: assign at least one assignment criteria to each managing entity of the plurality of managing entities; detect at least one newly available resource at a port of the host device, where the at least one newly available resource is initially connected to the default managing entity of the plurality of managing entities; identify at least one operational parameter of the at least one newly available resource; determine if the newly available resource should be assigned a new managing entity of the plurality of managing entities based at least in part on the identified at least one operational parameter; and select, when the newly available resource should be assigned a new managing entity, a managing entity based at least in part on the at least one assignment of each of the managing entities, otherwise maintain the connection to the default managing entity.

In another aspect, a system is disclosed. In one embodiment, the system comprises an “intelligent” host device and a connected device; the host is configured to dynamically determine an appropriate controller for the connected device.

In another aspect, an intelligent interface is disclosed. In one embodiment, the interface comprises a wired interface utilizing a high-speed serialized bus protocol, and is configured to determine one of a plurality of resource controllers that is appropriate for a connected device.

In another aspect, a host controller is disclosed.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a logical flow diagram of one embodiment of a generalized method for dynamically allocating detected resources to available resource controllers.

FIG. 2A is a logical flow diagram of an exemplary implementation of a method for dynamically allocating a detected USB device to available USB controllers in accordance with the present disclosure.

FIG. 2B is a logical flow diagram of an exemplary implementation of a method for dynamically reallocating a port connection in response to a USB device being disconnected from the port in accordance with the present disclosure.

FIG. 3 is a functional block diagram illustrating an exemplary embodiment of an apparatus configured to dynamically allocate resources to available controllers in accordance with the present disclosure

FIG. 4 is a functional block diagram illustrating an exemplary embodiment of controller architecture in accordance with the present disclosure.

All Figures © Copyright 2013 Apple Inc. All rights reserved.

### DETAILED DESCRIPTION

### Overview

The present disclosure provides, inter alia, methods and apparatus for dynamically routing detected devices to controller resources to, among other things, improve resource usage. In one embodiment, the controllers comprise multiple Universal Serial Bus (USB) controllers (e.g., an Enhanced Host Controller Interface (EHCI) controller, an eXtensible Host Controller Interface (xHCI) controller, etc.) When a USB-compliant device is detected, one or more determinations are made regarding the detected device such as, for example, the supported data transfer speed capabilities (e.g., Low-speed, Full-speed, High-speed, and SuperSpeed). Based on the one or more determinations, the device is directed to an appropriate controller. Advantageously, embodiments of the present disclosure provide effective resource usage by directing detected devices to appropriate controllers configured to support detected capabilities of the device.

### DETAILED DESCRIPTION OF EXEMPLARY EMBODIMENTS

Exemplary embodiments of the present disclosure are now described in detail. While these embodiments are discussed primarily in terms of a serial bus that is compliant with the Universal Serial Bus (USB) standard, it will be recognized by those of ordinary skill that the present disclosure is not in any way limited to a USB-compliant serial bus. In fact, various other applications and embodiments (whether to other types of serial buses, or otherwise) are also possible in accordance with the disclosure, and considered to be within the scope thereof.

Moreover, as used herein the term “endpoint” generally refers to the portion of a device that is a source and/or a sink of information in a communication flow between devices, and should in no way be considered limiting; i.e., a client device or other entity may or may not comprise a logical or physical “endpoint” within the network.

As used herein, the term “serial bus” refers without limitation to any bus or other data transfer, transmission, receipt, or interface structure adapted to operate according to a serialized protocol. Examples of such serialized protocols include the USB (universal serial bus) protocol, USB 2.0, USB On-The-Go (OTG), USB 3.0, Thunderbolt™, etc. In the exemplary USB context, devices are connected in a so-called tiered-star topology, where a host device resides at a central position, and manages communication to various client devices within a given USB network. The “host” devices are characterized as such in that they contain a USB Host Controller (HC), Each USB host may have multiple USB Host Controllers (HCs), and each HC may provide one or more USB ports. USB devices are generally linked in series through hubs.

Host devices and client devices may include, but are not limited to, personal computers (PCs) (whether desktop, laptop, handheld or otherwise), and mobile devices such as smartphones, tablets/phablets, PDAs, digital and video cameras, personal media devices (PMDs) (such as MP3 players, printers or rendering devices), or any combinations of the foregoing.

When a user plugs a USB device into a USB port, enumeration of the device by a connected host controller is initialized. Enumeration is a process of loading the necessary drivers of the connected USB device through detection and identification of the USB device. A USB device is typically detected via a monitored change in the bus lines of the USB port when the USB device is plugged in. For example, a differential voltage may be monitored between data lines of the USB bus. The detected change in the data lines may be used, in the case of USB 2.0 or below, for determining a connection speed of the USB device. After the USB device has been detected and connection speed determined, the controller of the USB port can request and retrieve information from the USB device. Using the collected information, a driver for the device may be located and loaded to so that USB is available for use with the host device.

### Method—

Referring now to FIG. 1, one embodiment of a generalized method 100 for dynamically allocating detected resources to available resource controllers is shown and described. While various embodiments of the method discussed herein are generally described in the context of Universal Serial Bus compliant controllers and devices, the concepts described below are in no way limited. For example, the present disclosure may be applied to various technologies which implement controller-based management of resources, such as for example Thunderbolt compliant devices.

At step 102, one or more parameters of a resource are detected. In one embodiment, the resource is a device, and a resource controller is configured to detect the one or parameters of a device when the device is inserted into a communication port of a host device. The one or more parameters of the inserted device may also be detected upon a boot operation of the host device. In one variant, the one or more parameters relate to operational parameter of USB devices. For example, the detected operational parameters may be related to the supported data transfer speed of the device (e.g. Low-speed, High-speed, SuperSpeed, etc.). Additionally, the one or more operational parameters may relate to a number of endpoints required to support full operation of the device. In one variant, the one or more parameters comprise a determined device class of the detected device. The resource controller may be able to drive other parameters from the detected device class such as, for example, the connection speed of the device.

In one variant, the one or more parameters are detected after the resource controller sends a command in response to detecting a new presence of a device.

In another variant, the one or more parameters may relate to power requirements of the detected device. For example, the one or more parameters may concern a minimum required supply voltage or current, or may indicate a maximum expected power requirement.

In yet another variant, the one or more parameters are related to operational parameters of display devices. For example, the communication protocol used by the device may be detected.

At step 104, a controller resource is selected based at least in part on the detected one or more parameters. In one embodiment, the controller resource is selected based on a comparison of the detected parameters against capabilities of available resource controllers. In one variant, the selection is based by assuming resource complexity associated with the detected one or more parameters. For example, USB devices configured to communicate at Low-speed are generally less complex and require less endpoint resources. Furthermore, Low-speed device may be deemed unlikely to be a hub device linking additional USB devices to a single port, thereby reducing a perceived risk of a possible high end point and device resource load on a controller.

As a brief aside, in certain implementations, a USB controller may be limited a number of endpoints and devices supported by a USB controller at any one time. For example, the USB controller may enumerate devices only to local memory, such as registers, of the USB controller as compared to storing the records in external memory. Thus an exemplary USB controller may contain sixty-four registers for storing endpoint record information and therefore may only support a maximum of sixty-four endpoints.

Therefore, in an exemplary implementation, the detected parameters comprise a number of endpoints required by a USB device, the resource controller may be selected based on the available end points resources of the available resource controllers to more effective balance the load between the resource controllers.

In one variant, the detected parameters are used to select a controller resource which is compatible to communicate and/or control a device. By allowing a dynamic selection of a controller resource based at least in part on the detected one or more parameters, the port which are used to connect a device may be undifferentiated to a user of the host device. Thus, the user may plug in a device to a port without requiring knowledge of whether the port is connected to a controller resource best suited to serve the device and all of its associated capabilities. For example, a plurality of controller resources may be able to perform basic communication with a connected device; however, only a subset of the controller resources may be able to control and/or communicate with particular functions of the connected device.

In another embodiment, a controller resource is selected based at least in part on resources usage of available controller resources. By basing the selection of the current resources, the controller resource may be selected in order to load balance between the available controllers resources based on the detected parameters.

At step 106, the resource is routed to the selected controller resource. In one embodiment, a device resource is routed to the selected controller resource through the use of one or more multiplexers in data communication with a port of the connected device and the selected controller resource. In one variant, the multiplexer is controlled by a controller resource configured to detect the one or more parameters. In another variant, the multiplexer is controlled by a functional entity separate from the controller resources. In one implementation, upon detecting that the device has been disconnected, the route is selected back to a default connection or position. Additionally, the default connection may be restored based on a reboot operation of the host device.

At step 108, the source is controlled with the selected resource controller. In one embodiment, the selected resource controller is at least one USB interface controller, such an MCI or xHCI controller, which enumerates a device resource and its corresponding capabilities to be accessible by other processes of the host device. After enumeration, the device is available

### Example Operation—

Referring now to FIG. 2A, one exemplary embodiment of a method for dynamically allocating a detected USB device to available USB controllers is shown and described. In one embodiment, the available controllers comprise an xHCI controller configured to support USB 3.0 standard and below, and an EHCI controller configured to support USB 2.0 standard and below.

As a brief aside, the xHCI controller configured to support USB 3.0 is able to support the connection speeds of USB 2.0 and below in addition to the connection speed of USB 3.0 (i.e. SuperSpeed). Additionally, USB 2.0 speeds and a USB 3.0 SuperSpeed are implemented on different bus architecture. The xHCI controller achieves the aforementioned support with the use of one or more ports configured with USB 2.0 compliant bus architecture as well as one or more ports configured with USB 3.0 SuperSpeed bus architecture. Accordingly, an EHCI controller configured to support only USB 2.0 cannot support the USB 3.0 SuperSpeed connection as it does possess the requisite bus architecture.

At step 202, a user plugs a USB device into a port of a host device that is in data communication with the xHCI controller. The xHCI controller detects the insertion of the USB device and proceeds to determine the connection speed supported by the USB device. For example, with respect to USB 2.0 or lower devices, the xHCI may monitor voltages on the D+/D− bus lines to determine the supported speed of the device. In addition, the xHCI will monitor for an attempt by the device to establish a connection over the USB 3.0 SuperSpeed bus lines.

At step 204, if the xHCI controller determines that the USB device is connecting according to a High-speed (HS) protocol, the method proceeds to step 206 to direct a multiplexer in data communication with the port of the USB device. If the xHCI controller determines that the USB is connecting at a connection speed protocol other than HS, the method proceeds to step 208.

At step 206, the xHCI controller sends a signal to a multiplexer to direct the multiplexer to route the data connection of the port in which the USB device is plugged to an available EHCI controller, or a Rate Matching Hub (RMH) in data communication with the EHCI controller. Once the multiplexer has routed the data communication of the USB device to the EHCI, thereby disconnecting the USB device from xHCI controller, the EHCI proceeds to enumerate the USB device per step 210. As the disconnection from the xHCI occurs without the need to request device information to identify a driver of the USB device, unnecessary enumeration steps are avoided by the xHCI controller. Furthermore, as there has been no driver software loaded by the host device for the USB device, there is no harm of immediately disconnecting the USB device from the xHCI controller during the multiplexing procedure.

At step 208, the xHCI controller maintains data communication with USB device. If the USB device was determined to be attempting to connect at a Low-speed connection, the xHCI proceeds to enumerate the device via the xHCI port configured to support the USB 2.0 bus architecture. If the USB device is determined to be attempting to connect at a SuperSpeed connection, the xHCI proceeds to enumerate the device, via a USB driver, through the xHCI port configured to support the USB 3.0 bus architecture.

Referring now to FIG. 2B, one exemplary embodiment of a method for dynamically reallocating a port connection in response to a USB device being disconnected from a port is described. The dynamically allocation is used to restore the connection of the port of the disconnecting device to prepare the port for the dynamic allocation of a detected device as discussed above.

At step 220, the USB hub driver of the controller responsible for the USB device detects that the USB device has been disconnected from a port from a user. For example, a disconnection may be detected by a change in voltage on the data lines of the USB port associated with the device.

At step 222, the USB hub driver determines if the USB device was multiplexed to the EHCI and/or an associated RMH. If so, at step 224, the USB hub driver sends a message to the xHCI to request that the xHCI to route the port of the USB device back to the xHCI controller, per step 224.

If not, the USB hub driver determines that no further operations on its part are needed performs no operation per step 226.

At step 224, the xHCI sends a signal to the multiplexer to multiplex the port away from an EHCI back to the port of the xHCI configured according to the USB 2.0 bus architecture per step 228. By switching the port back to the xHCI, the xHCI determined the connection speed of a subsequent detection of a USB device.

### Exemplary Apparatus—

FIG. 3 illustrates one exemplary embodiment of an apparatus (e.g., host device) useful for implementing the methods of the present disclosure. The host device 300 illustrated includes a plurality of controller units 302, which manages communications between endpoints. Each of the plurality of controller units 302 may be configured with driver software has the responsibility for managing the work for the respective controller unit.

The illustrated apparatus of FIG. 3 further includes a processor subsystem 304 such as a digital signal processor, microprocessor, field-programmable gate array, or plurality of processing components mounted on one or more substrates. The processing subsystem may also comprise an internal cache memory. The processing subsystem is connected to a memory subsystem 306 comprising memory which may for example, comprise SRAM, Flash and SDRAM components. The memory subsystem 306 may implement one or a more of DMA type hardware, so as to facilitate data accesses as is well known in the art. The memory subsystem contains computer-executable instructions which are executable by the processor subsystem 304.

The illustrated apparatus further includes one or more interfaces 308. The one or more interfaces 308 may comprise interfaces internal to the apparatus or may comprise external interfaces (e.g., FireWire™, Universal Serial Bus™ (USB), Thunderbolt, and/or other interfaces.)

The controller units 302, in one embodiment, are rendered as one or more integrated circuits. As used herein, the term “integrated circuit (IC)” refers to any type of device having any level of integration (including without limitation ULSI, VLSI, and LSI) and irrespective of process or base materials (including, without limitation Si, SiGe, CMOS and GaAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof. The plurality of controller units 302 are responsible for, inter alia, management and control functionality of resources/devices connected to the one or more interfaces 308. Thus the controller units 302 provide a means for the connected resource/device to communicate and operate with the host device 300.

The apparatus further includes a detection unit or logic 310 coupled to the one more interfaces 308. The detection unit 310 is configured to detect one or more parameters of resources attempting to access the one or more interfaces 308. In one embodiment, the detection unit 310 is implemented in one or more of the plurality of controller units 302. In one implementation, the detection unit 310 is configured to receive USB 2.0 bus lines (i.e. D+/D−) as well as USB 3.0 SuperSpeed bus lines from the one or more interfaces 308. Accordingly, the detection unit 310 may detect one or more parameters of a connecting device via either the USB 2.0 or 3.0 bus lines, depending on how the connecting device is attempting to connect.

In another embodiment, the detection unit 310 is implemented in software stored in the memory subsystem 306 and executed by the processing subsystem 304.

A switching unit 312 is coupled to the one or more interfaces 308 and the plurality of controller units 302. The switching unit 312 is configured to route various connections from one or more interfaces 308 to a selected controller unit 304. In one embodiment, the switching unit 312 is configured to receive a control signal from the detection unit 310. The control signal directs the switching unit 312 to route a connection from one or more of the interfaces 308 to a desired controller unit(s) 304.

The device may also include a user interface subsystem (not shown) that includes any number of well-known I/O including, without limitation: a keypad, touch screen (e.g., multi-touch interface), LCD display, backlight, speaker, and/or microphone. However, it is recognized that in certain applications, one or more of these components may be obviated.

Referring now to FIG. 4, an exemplary embodiment of controller architecture 400 useful in implementing the various aspects of the present disclosure is shown and described. The controller architecture comprises a xHCI controller 402, two EHCI controllers 404, two Rate Matching Hubs (RMH) 406, and a multiplexer 408 controlled by the xHCI controller (xMux). In addition, a plurality of USB socket connector ports 410 are configured with USB 2.0 bus lines and USB 3.0 SuperSpeed (SS) bus lines. The SS bus lines are routed to various ports of the xHCI controller 402. The USB 2.0 bus lines are routed to the xMux 408. Some of the USB socket connectors 410 may contain an electrical multiplexer system (eMux) 412 configured to allowed the xMux 408 to instruct the eMux 412 to route the USB 2.0 bus lines directly to another RMH 406, and accordingly a separate MCI controller 404. The RMH 406 additional have dedicated connections to various other components such as a camera device (e.g. Apple's iSight®) or an internal root hub. The internal root hub 414 may be connected to a variety of USB peripherals such as, for example, infrared, SD card reader, keyboard, Bluetooth, or other (e.g., TP)

The xHCI controller 402 is configured to detect whether a device is attempting to connect via the SS bus lines or the USB 2.0 bus lines. The xHCI controller 402, in the exemplary illustration, is the only controller configured to handle SS devices so any device connecting via the SS bus lines will be maintained by the xHCI controller 402. If a device is connecting via USB 2.0 data lines, the xHCI controller 402 may decide to maintain control of the device itself or route the device to an EHCI controller 404 accordingly by sending an appropriate command to the xMux 408. The decision to route the USB 2.0 bus lines of a socket connector 410 may be formulated based on various methodologies as discussed herein in the present disclosure.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed is:

1. A method for dynamically allocating resources to a plurality of resource controllers, the method comprising:
detecting one or more parameters associated with a resource;
selecting at least one resource controller of the plurality of resource controllers for the resource based at least in part on the detected one or more parameters; and
routing a connection to the selected at least one resource controller.

2. The method of claim 1, wherein the detecting is performed at least in response to determining the resource is currently unassigned at least one resource controller of the plurality of resource controllers.

3. The method of claim 1, wherein at least the detecting is performed by a default resource controller configured for initially communicating with the resource.

4. The method of claim 3, wherein the default resource controller comprises a Universal Serial Bus (USB) 3.0 compliant controller, and at least one of the plurality of resource controllers comprises a USB 2.0 compliant controller; and
wherein the resource comprises a USB compliant device.

5. The method of claim 4, wherein the detected one or more parameters comprises a USB connection speed of the device; and
wherein the selection between either the USB 3.0 compliant controller and a USB 2.0 controller is based at least on the detected USB connection speed of the device.

6. The method of claim 3, wherein the default resource controller is configured to control the routing of the connection.

7. The method of claim 1, further comprising:
identifying a removal of the resource from the selected controller; and
resetting the routed connection to a default connection in response to the identified removal.

8. A host device configured to dynamically allocate device resources among a plurality of resource controllers, the host device comprising:
at least one interface;
a plurality of resource controllers; and
computerized logic in data communication with the at least one interface and the plurality of resource controllers, the computerized logic configured to cause the host device to:
identify at least one device attempting to establish a new connection with the host device via the at least one interface;
determine one or more characteristics of the at least one device; and
based at least in part on the one or more characteristics, select at least one resource controller of the plurality of resource controllers to associate with the at least one device.

9. The host device of claim 8, wherein the computerized logic is further configured to cause the host device to
determine available resources of one or more resources controllers suitable to control the at least one device;
wherein the selection of the at least one controller is further based at least in part on the determined available resources.

10. The host device of claim 9, wherein the available resources comprise at least one of (i) available endpoints resources, and/or (ii) available device resources of the one or more resource controllers; and
wherein the determined one or more characteristics comprise a number of endpoints resources required to adequately service functionality of the at least one device.

11. The host device of claim 8, wherein the at least one device is initially in data communication with a default resource controller of the plurality of resource controllers via the at least one interface.

12. The host device of claim 11, wherein the selected at least one resource controller is different than the default resource controller when the determined one or more characteristics do not correspond to desired one or more parameters of the default resource controller.

13. The host device of claim 12, further comprising a switching unit in data communication with the at least one interface, the plurality of controllers, and the computerized logic;
wherein the computerized logic is further configured to cause the host device to:
route the at least one device from the default controller to the different controller via the switching unit.

14. The host device of claim 8, wherein the plurality of controllers are selected from a group consisting of: (i) Universal Serial Bus controllers, (ii) power controllers, and (iii) display device controllers.

15. A non-transitory computer readable apparatus having a storage medium with at least one computer program disposed thereon, the at least one program comprising a plurality of instructions for dynamically allocating resources between a plurality of managing entities stored thereon, the plurality of instructions configured to, when executed by a processor, cause a host apparatus to:
assign at least one assignment criteria to each managing entity of the plurality of managing entities;
detect at least one newly available resource at a port of the host device, where the at least one newly available resource is initially connected to the default managing entity of the plurality of managing entities;
identify at least one operational parameter of the at least one newly available resource;
determine if the newly available resource should be assigned a new managing entity of the plurality of managing entities based at least in part on the identified at least one operational parameter; and
select, when the newly available resource should be assigned a new managing entity, a managing entity based at least in part on the at least one assignment of each of the managing entities, otherwise maintain the connection to the default managing entity.

16. The non-transitory computer readable apparatus of claim 15, wherein the default managing entity is configured to be serve all resources by the plurality of managing entities.

17. The non-transitory computer readable apparatus of claim 15, wherein the newly available resource comprises a device connected to a port of the host device.

18. The non-transitory computer readable apparatus of claim 16, wherein the default managing entities comprises a Universal Serial Bus (USB) 3.0 compliant controller, and at least one other managing entity comprises a USB 2.0 compliant controller.

19. The non-transitory computer readable apparatus of claim 15, wherein the plurality of instructions are further configured to, when executed, cause the host device to evaluate respective resource loads for each managing entity of at least a subset of the plurality of managing entities;
wherein the selection is further based at least in part on the evaluated resource loads.

20. The non-transitory computer readable apparatus of claim 19, wherein the plurality of instruction are further configured to, when executed, cause the host device to, when the newly available resource was assigned to the new managing entity, reassign the default managing entity to the port associated with the newly available resource upon a disconnection of the newly available resource from the port.
